(19) United States
(12) Patent Application Publication
(10) Pub. No.: US 2024/0222725 A1
(43) Pub. Date: Jul. 4, 2024

(54) EARLY WARNING METHOD AND SYSTEM FOR DENDRITE FORMATION IN LITHIUM BATTERY

(71) Applicant: Shanghai Makesens Energy Storage Technology Co., Ltd., Shanghai (CN)

(72) Inventors: Danfei Gu, Shanghai (CN); Mingchen Jiang, Shanghai (CN); Qian Li, Shanghai (CN); Siyuan Chen, Shanghai (CN); Liangchang Wei, Shanghai (CN); Xiao Yan, Shanghai (CN); Enhai Zhao, Shanghai (CN)

(21) Appl. No.: 18/392,051

(22) Filed: Dec. 21, 2023

(30) Foreign Application Priority Data
Dec. 29, 2022 (CN) 202211710774.4

(51) Int. Cl. H01M 10/48; H01M 10/0525

(52) U.S. Cl. CPC H01M 10/48; H01M 10/0525; H01M 2200/00

(57) ABSTRACT

The invention provides a method and a system for early warning of dendrite formation in a lithium battery. The method includes acquiring real-time operating condition information and electrochemical parameters of the lithium battery; performing a computational simulation based on the real-time operating condition information and the electrochemical parameters through an electrochemical model, and obtaining by analysis a deposition result of the lithium battery; and using the deposition result obtained through electrochemical model simulation, providing early warning for the dendrite formation in the lithium battery. The invention avoids the growth of dendrites of the lithium battery by providing early warning and simulation for dendrite formation, thereby protecting the safety of the lithium battery system.

### CROSS-REFERENCE TO RELATED PATENT APPLICATION

This application claims priority to and the benefit of Chinese Patent Application No. 202211710774.4, filed Dec. 29, 2022, which is incorporated herein in its entirety by reference.

### FIELD OF THE INVENTION

The invention relates generally to the field of battery management, and more particularly to a method and a system for early warning of dendrite formation in a lithium battery.

### BACKGROUND OF THE INVENTION

In the context of global “carbon neutrality,” enthusiasm for finding clean energy alternatives to petroleum energy continues to rise. Clean and sustainable energy sources such as solar power, tidal energy, wind power, and hydropower are available, but the controllability of the medium generated by these energy sources is relatively weak. Lithium-ion batteries are a new generation of secondary batteries with high energy density and cycle life. They are currently widely used in mobile communications, digital technology, electric vehicles, energy storage, and other fields. The future demand for lithium batteries and their materials is difficult to estimate, and the corresponding upstream and downstream industrial chains also present a huge market.

As the current applications of lithium batteries continue to expand, the safety hazards associated with these batteries are increasingly drawing attention. From mobile phones and laptops to electric vehicles, incidents of lithium-ion batteries heating up or even catching fire have occurred. This phenomenon is no longer limited to counterfeit electronic products. Safety incidents involving lithium-ion batteries have involved brands such as Nikon, Panasonic, Samsung, Xiaomi, Lenovo, Tesla, and others.

Lithium dendrites are one of the fundamental issues affecting the safety and stability of lithium-ion batteries and are an industry pain point. The formation of lithium dendrites can lead to instability at the electrode-electrolyte interface of the lithium-ion battery during cycling. The growth of lithium dendrites can destroy a generated Solid Electrolyte Interface (SEI) film. The lithium dendrites can continuously consume electrolytes in the generation process and cause irreversible deposition of metallic lithium. This results in the formation of dead lithium, leading to low Coulombic efficiency, and can even pierce the separator, causing internal short circuit of the lithium-ion battery. This internal short circuit can trigger thermal runaway, leading to combustion and explosion of the battery.

Therefore, a heretofore unaddressed need exists in the art to address the aforementioned deficiencies and inadequacies.

### SUMMARY OF THE INVENTION

In view of the above-noted shortcomings, one of the objectives of this invention is to provide an early warning method for dendrite formation in a lithium battery.

In one aspect of the invention, the method includes:
acquiring real-time operating condition information and electrochemical parameters of the lithium battery;
performing a computational simulation based on the real-time operating condition information and the electrochemical parameters through an electrochemical model, and obtaining by analysis a deposition result of the lithium battery; and
using the deposition result obtained through electrochemical model simulation, providing early warning for the dendrite formation in the lithium battery.

In some embodiments, the performing the computational simulation based on the real-time operating condition information and the electrochemical parameters through the electrochemical model comprises:
simulating a relationship between a lithium plating amount and an overpotential of the lithium battery based on the real-time operating condition information and the electrochemical parameters through the electrochemical model.

In some embodiments, the simulating the relationship between the lithium plating amount and the overpotential of the lithium battery based on the real-time operating condition information and the electrochemical parameters through the electrochemical model comprises: a formula of the overpotential of:

$${η}_{plating} = {Φ}_{s} - {Φ}_{e} - {E}_{plating} - {aFj}_{n} R ;$$

wherein η is the overpotential, Φₛ is a solid phase potential, Φₑ is a liquid phase potential, E_{plating} is an equilibrium potential for a lithium plating reaction, α is a specific surface area, jₙ is a solid-liquid exchange current density, and R is SEI impedance; and the lithium plating amount satisfying the BV equation for a lithium plating side reaction by a formula of:

$${i}_{plating} = {i}_{o} [ exp ( \frac{{α}_{a} F {η}_{plating}}{RT} ) - exp ( \frac{{α}_{c} F {η}_{plating}}{RT} ) ] ; \\ {i}_{0} = {kCe}^{α} ;$$

wherein i₀ is a reference current density, Cₑ is a liquid phase concentration, α is an oxidation-reduction reaction coefficient, αₐ and α_{c} are anodic and cathodic transfer coefficients, respectively, F is a Faraday constant, R is a universal gas constant, T is a temperature in Kelvin, and i_{plating} is a lithium plating rate at a specific location per unit time. In some embodiments, the obtaining by analysis the deposition result of the lithium battery comprises:

based on the liquid phase concentration of the lithium battery, obtaining by analysis the deposition result of the lithium battery.

In some embodiments, the based on the liquid phase concentration of the lithium battery, obtaining by analysis the deposition result of the lithium battery comprises:
judging whether or not the liquid phase concentration of the lithium battery is lower than a preset threshold value and is close to 0; and
when the liquid phase concentration of the lithium battery is lower than a preset threshold value and is close to 0, determining that the deposition result of the lithium battery is occurrence of dendrites in the lithium battery.

In some embodiments, the based on the liquid phase concentration of the lithium battery, obtaining by analysis the deposition result of the lithium battery further comprises:
if not, extrapolating the current operating condition of the lithium battery, and judging in different ways in different scenarios whether to provide the early warning for the lithium battery.

In some embodiments, the judging in different ways in different scenarios whether to provide the early warning for the lithium battery comprises:
when the lithium battery is in an energy storage power station within a preset stable range, extrapolating using a preset time average value of the lithium battery.

In some embodiments, the judging in different ways in different scenarios whether to provide the early warning for the lithium battery comprises:
when the lithium battery is in a frequency modulation power station, predicting the source-grid-load-storage in different cycles of the lithium battery.

In some embodiments, the judging in different ways in different scenarios whether to provide the early warning for the lithium battery comprises:
when the lithium battery is in a power tram, by extrapolating using a maximum current within a preset time period, judging whether the maximum current is close to 0 within the preset time threshold;
wherein the preset time threshold comprises a time threshold obtained through analysis according to a data sampling time of a lithium battery system and a control response time of the lithium battery system.

In another aspect, the invention relates to an early warning system for dendrite formation in a lithium battery, comprising:
an acquisition module configured to acquire real-time operating condition information and electrochemical parameters of the lithium battery;
a simulation module configured to perform computational simulation based on the real-time operating condition information and the electrochemical parameters through an electrochemical model, and obtain by analysis a deposition result of the lithium battery; and
an early warning module configured to, using the deposition result obtained through electrochemical model simulation, provide early warning for the dendrite formation in the lithium battery.

Compared with the prior art, the method and system for early warning of dendrite formation in a lithium battery provided by the invention can at least bring the following beneficial effects:

The invention prevents the growth of dendrites of the lithium battery by carrying out early warning and simulation for dendrite formation, thereby protecting the safety of the lithium battery system.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 is a flowchart of an early warning method for dendrite formation in a lithium battery according to embodiments of the invention.

FIG. 2 is another flowchart of an early warning method for dendrite formation in a lithium battery according to embodiments of the invention.

FIG. 3 is a schematic diagram of an early warning system for dendrite formation in a lithium battery.

### DETAILED DESCRIPTION OF THE INVENTION

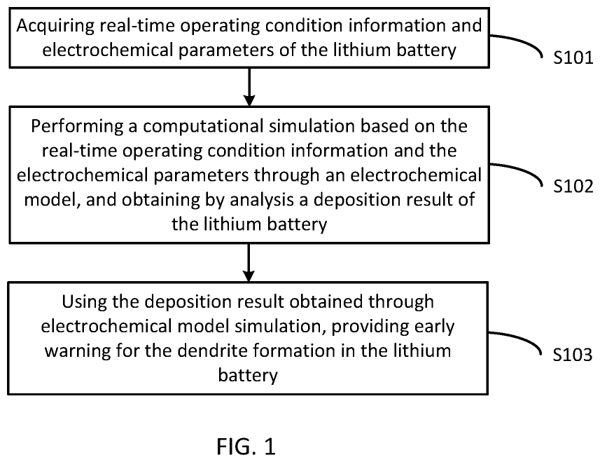

Embodiments of the invention are described below through specific examples in conjunction with the accompanying drawings in FIGS. 1-3, and those skilled in the art can easily understand other advantages and effects of the invention from the content disclosed in this specification. The invention can also be implemented or applied through other different specific implementations, and various modifications or changes can be made to the details in this specification according to different viewpoints and applications without departing from the spirit of the invention. It should be noted that, in the case of no conflict, the following embodiments and features in the embodiments can be combined with each other.

It should be noted that the drawings provided in the following embodiments are merely illustrative in nature and serve to explain the principles of the invention, and are in no way intended to limit the invention, its application, or uses. Only the components related to the invention are shown in the drawings rather than the number, shape and size of the components in actual implementations. For components with the same structure or function in some figures, only one of them is schematically shown, or only one of them is marked. They do not represent the actual structure of the product. Dimensional drawing, the type, quantity and proportion of each component can be changed arbitrarily in its actual implementations. More complicate component layouts may also become apparent in view of the drawings, the specification, and the following claims.

The terminology used herein is for the purpose of describing particular embodiments only and is not intended to be limiting of the invention. As used herein, “a” not only means “only one,” but also means “more than one.” The term “and/or” used in the description of the present application and the appended claims refers to any combination and all possible combinations of one or more of the associated listed items, and includes these combinations. The terms “first,” “second,” etc. are only used for distinguishing descriptions, and should not be construed as indicating or implying relative importance.

It should be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

In order to more clearly illustrate the embodiments of the invention or the technical solutions in the prior art, the following description will explain the specific embodiments of the invention with reference to the accompanying drawings. It is evident that the drawings in the following description are only examples of the invention, from which other drawings and other embodiments can be obtained by a person skilled in the art without inventive effort.

In one embodiment, as shown in FIG. 1, the early warning method for dendrite formation in a lithium battery includes the following steps:

S101, acquiring real-time operating condition information and electrochemical parameters of the lithium battery.

In this embodiment, the real-time operating condition information refers to operating condition information for controlling charge and discharge of the battery.

Illustratively, real-time operating condition information includes current-time information, voltage-time information, and power-time information.

In an actual scenario, if the battery is charged and discharged through current control, the real-time operating condition information is current-time information. If the battery is charged and discharged through voltage control, the real-time operating condition information is voltage-time information. If the battery is charged and discharged through power control, the real-time operating condition information is power-time information.

In this embodiment, the lithium battery parameters are the electrochemical parameters of the electrochemical model used.

S102, performing a computational simulation based on the real-time operating condition information and the electrochemical parameters through an electrochemical model, and obtaining by analysis a deposition result of the lithium battery.

Specifically, the real-time operating condition information and the physical and chemical parameters of lithium battery parameter identification are loaded into a battery electrochemical model to be simulated.

In this embodiment, the electrochemical model simulates the just-loaded parameters in real time.

It should be noted that negative electrode lithium deposition generally occurs before lithium dendrites appear. Lithium dendrites are a particular form of lithium deposition. The growth of lithium deposits changing from mossy lithium to lithium dendrites happens when the mass transfer process cannot keep up with the electrochemical reaction rate, resulting in uneven lithium deposition. At this time, the liquid phase concentration near the lithium deposition is 0 or close to 0, and at this time, the deposition growth guided by the concentration field changes into that guided by the electric field, and the uneven growth form is dendrites.

Before assessing the presence of dendrites, the lithium deposition situation is first considered in the electrochemical model. The electrochemical model of the present invention may not be a full-order or other field coupled electrochemical model, but must be coupled with the influence of lithium deposition.

S103, using the deposition result obtained through electrochemical model simulation, providing early warning for the dendrite formation in the lithium battery.

In this embodiment, by providing early warning and simulation for dendrite formation, the growth of lithium battery dendrites is avoided, thereby protecting the safety of the lithium battery system.

In one embodiment, the performing the computational simulation based on the real-time operating condition information and the electrochemical parameters through the electrochemical model includes:
simulating a relationship between a lithium plating amount and an overpotential of the lithium battery based on the real-time operating condition information and the electrochemical parameters through the electrochemical model.

There are various ways to judge the occurrence of deposition, and in this embodiment, judgment is based on an overpotential equal to or less than 0.

In one embodiment, the simulating the relationship between the lithium plating amount and the overpotential of the lithium battery based on the real-time operating condition information and the electrochemical parameters through the electrochemical model includes: a formula of the overpotential of:

$${η}_{plating} = {Φ}_{s} - {Φ}_{e} - {E}_{plating} - {aFj}_{n} R ;$$

wherein n is the overpotential, Φₛ is a solid phase potential, Φₑ is a liquid phase potential, E_{plating} is an equilibrium potential for a lithium plating reaction, a is a specific surface area, jₙ is a solid-liquid exchange current density, and R is SEI impedance; and
the lithium plating amount satisfying the BV equation for a lithium plating side reaction by a formula of:

$${i}_{plating} = {i}_{o} [ exp ( \frac{{α}_{a} F {η}_{plating}}{RT} ) - exp ( \frac{{α}_{c} F {η}_{plating}}{RT} ) ] ; \\ {i}_{0} = {kCe}^{α} ;$$

wherein i₀ is a reference current density, Cₑ is a liquid phase concentration, a is an oxidation-reduction reaction coefficient, αₐ and α_{c} are anodic and cathodic transfer coefficients, respectively, F is a Faraday constant, R is a universal gas constant, T is a temperature in Kelvin, and i_{plating} is a lithium plating rate at a specific location per unit time.

In this embodiment, E_{plating} is the equilibrium potential for the lithium plating reaction, usually a negative number close to 0 but varying with the environment.

In this case, considering the conditions of the lithium plating reaction, the electrochemical model is used to simulate the relationship between the lithium plating rate at a specific location per unit time and the overpotential at that location.

In the original calculation of the electrochemical model, the amount of lithium ions in the solid phase and the liquid phase is conserved. However, in this embodiment, part of the amount of lithium ions originally conserved in the solid phase and the liquid phase undergoes lithium plating in the solid-liquid exchange process, so that the total amount of available lithium ions is reduced.

In one embodiment, the obtaining by analysis the deposition result of the lithium battery includes:
based on the liquid phase concentration of the lithium battery, obtaining by analysis the deposition result of the lithium battery.

In one embodiment, the based on the liquid phase concentration of the lithium battery, obtaining by analysis the deposition result of the lithium battery includes:
judging whether or not the liquid phase concentration of the lithium battery is lower than a preset threshold value and is close to 0; and
when the liquid phase concentration of the lithium battery is lower than a preset threshold value and is close to 0, determining that the deposition result of the lithium battery is occurrence of dendrites in the lithium battery.

Specifically, in step S3, judgment and early warning for precipitation of lithium dendrites: it is determined whether a liquid phase concentration field is below a certain threshold value and close to 0. The determination is based on the liquid phase concentration Cₑ. If so, appearance of dendrites is indicated, and if not, extrapolation is performed on the current operating conditions.

In one embodiment the method includes:
if not, extrapolating the current operating condition of the lithium battery, and judging in different ways in different scenarios whether to provide the early warning for the lithium battery.

In one embodiment, the judging in different ways in different scenarios whether to provide the early warning for the lithium battery includes:
when the lithium battery is in an energy storage power station within a preset stable range, extrapolating using a preset time average value of the lithium battery.

In one embodiment, the judging in different ways in different scenarios whether to provide the early warning for the lithium battery includes:
when the lithium battery is in a frequency modulation power station, predicting the source-grid-load-storage in different cycles of the lithium battery.

In one embodiment, the judging in different ways in different scenarios whether to provide the early warning for the lithium battery includes:
when the lithium battery is in a power tram, by extrapolating using a maximum current within a preset time period, judging whether the maximum current is close to 0 within the preset time threshold;
wherein the preset time threshold comprises a time threshold obtained through analysis according to a data sampling time of a lithium battery system and a control response time of the lithium battery system.

In the above embodiment, if so, determine that dendrites appear, and if not, perform extrapolation on the current operating conditions, which extrapolation will have different paradigms.

Generally, different methods of judging and early warning are performed on the lithium battery according to specific application scenarios. If it is predicted that, within a certain future time frame, the liquid phase concentration somewhere inside the battery is close to 0, an alarm is first issued, and future operating conditions need to be modified.

Illustratively, in a relatively stable energy storage power station, extrapolation is made with the most recent time average. The prediction focuses on whether, within a certain future time frame, the liquid phase concentration somewhere inside the battery is close to 0. If such a scenario is predicted, an alarm is first issued, and future operating conditions need to be modified.

Illustratively, for a frequency modulation power station, predictions are made based on large cycles and small cycles (monthly, weekly, daily) regarding source-grid-load-storage. If it is predicted that, within a certain future time frame, the liquid phase concentration somewhere inside the battery is close to 0, an alarm is first issued, and future operating conditions need to be modified.

Specifically, for a frequency modulation power station, modifications to problematic operating conditions are necessary. Here, additional simulations can be conducted to identify operating conditions that do not exceed the threshold and provide economic benefits.

As an illustrative example, for a power tram, extrapolation is made with the maximum current over a period of time. The prediction focuses on whether, within a certain future time frame, the liquid phase concentration somewhere inside the battery is close to 0. If such a scenario is predicted, an alarm is first issued, and future operating conditions need to be modified.

Specifically, modifying future operating conditions involves limiting output current or power or limiting output time.

The time threshold is generally determined by the battery system data sampling time and the battery system control response time.

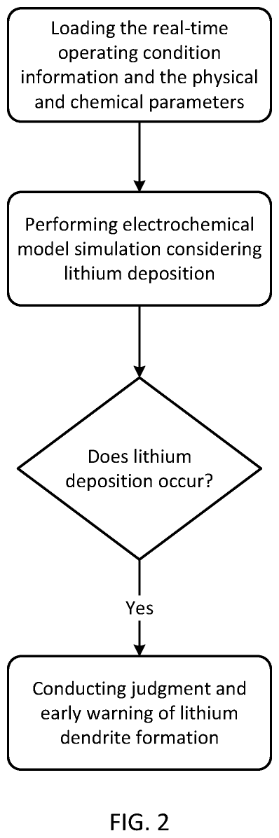

In one embodiment, as shown in FIG. 2, the early warning method for dendrite formation in a lithium battery includes:

the invention provides a numerical simulation and early warning method for dendrite formation in a lithium battery.

First, the real-time operating condition of a battery is acquired through a sensor, and the state parameters of the battery are acquired through a parameter identifier; then, the battery is simulated in real time through an electrochemical model; and finally, it is judged whether the liquid phase concentration field is lower than a certain threshold and is close to 0, if so, dendrites appear, if not, the current operating condition is extrapolated, and it is judged whether the situation that the liquid phase concentration field is close to 0 occurs within a certain time threshold. This threshold is most commonly taken to be 0, but in practice there will be a different threshold for different electrolytes of lithium batteries in experiments, which represents the difference in the diffusion capacity of the electrolyte itself for lithium-ion concentration. However, in common is a threshold value that is close to 0.

The invention relates to a numerical simulation and early warning method for dendrite formation in a lithium battery, comprising the following steps:

### Step S1, Parameter Loading

The real-time operating condition information and the physical and chemical parameters of the lithium battery parameter identification are loaded into a battery electrochemical model to be simulated.

The real-time operating condition information is what controls the charge and discharge of the battery. For current control, the real-time operating condition information is current-time information. For voltage control, the real-time operating condition information is voltage-time information. For power control, the real-time operating condition information is power-time information. With respect to the electrochemical model, the lithium battery parameters are the electrochemical parameters of the electrochemical model used.

### Step S2, Real-Time Simulation of Electrochemical Model

The just-loaded parameters of the electrochemical model are simulated in real time. It should be noted that negative electrode lithium deposition generally occurs before lithium dendrites occur. Lithium dendrites are a particular form of lithium deposition. The growth of lithium deposits changing from mossy lithium to lithium dendrites happens when the mass transfer process cannot keep up with the electrochemical reaction rate, resulting in uneven lithium deposition. At this time, the liquid phase concentration near the lithium deposition is 0 or close to 0, and at this time, the deposition growth guided by the concentration field changes into that guided by the electric field, and the uneven growth form is dendrites.

Before assessing the presence of dendrites, the lithium deposition situation is first considered in the electrochemical model. The electrochemical model of the present invention may not be a full-order or other field coupled electrochemical model, but must be coupled with the influence of lithium deposition.

There are various ways to judge the occurrence of deposition, and in this context, judgment is based on an overpotential equal to or less than 0.

The formula for overpotential is η_{plating}=Φₛ−Φₑ−E_{plating}−aFjₙR, wherein η is the overpotential, Φₛ is a solid phase potential, Φₑ is a liquid phase potential, E is an equilibrium potential for a lithium plating reaction (usually a negative number close to 0 but varying with the environment), α is a specific surface area, jₙ is a solid-liquid exchange current density, and R is SEI impedance.

The lithium plating amount follows the BV equation for a lithium plating side reaction:

$${i}_{plating} = {i}_{o} [ exp ( \frac{{α}_{a} F {η}_{plating}}{RT} ) - exp ( \frac{{α}_{c} F {η}_{plating}}{RT} ) ] ; \\ {i}_{0} = {kCe}^{α} ;$$

wherein i₀ is a reference current density, Cₑ is a liquid phase concentration, and a is an oxidation-reduction reaction coefficient.

In this case, considering the conditions of the lithium plating reaction, the electrochemical model is used to simulate the relationship between the lithium plating rate at a specific location per unit time and the overpotential at that location.

i_{plating} is a lithium plating rate at a specific location per unit time, i₀ is a reference exchange current density, da and ac are anodic and cathodic transfer coefficients, respectively, F is a Faraday constant, R is a universal gas constant, and T is a temperature in Kelvin.

In the original calculation of the electrochemical model, the amount of lithium ions in the solid phase and the liquid phase is conserved. However, in this embodiment, part of the amount of lithium ions originally conserved in the solid phase and the liquid phase undergoes lithium plating in the solid-liquid exchange process, so that the total amount of available lithium ions is reduced.

### Step S3, Judgment and Early Warning of Precipitation of Lithium Dendrites

It is determined whether a liquid phase concentration field is below a certain threshold value and close to 0. The determination is based on the liquid phase concentration Cₑ.

If so, appearance of dendrites is indicated, and if not, extrapolation is performed on the current operating conditions.

Generally, different methods of judging and early warning are performed on the lithium battery according to specific application scenarios. In a relatively stable energy storage power station, extrapolation is made with the most recent time average. For a frequency modulation power station, predictions are made based on large cycles and small cycles (monthly, weekly, daily) regarding source-grid-load-storage. For a power tram, extrapolation is made with the maximum current over a period of time, and it is judged whether the scenario of being close to 0 occurs within a certain time threshold. If so, early warning is provided.

The time threshold is generally determined by the battery system data sampling time and the battery system control response time.

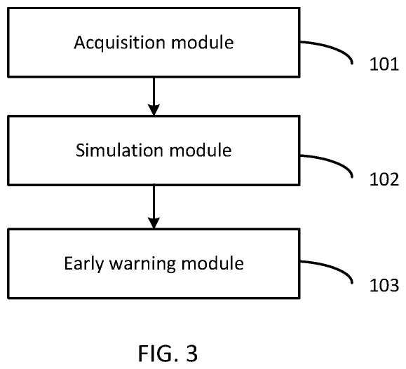

In one embodiment, as shown in FIG. 3, the early warning system for dendrite formation in a lithium battery includes the following:

An acquisition module 101 is configured to acquire real-time operating condition information and electrochemical parameters of the lithium battery.

In this embodiment, the real-time operating condition information refers to operating condition information for controlling charge and discharge of the battery.

Illustratively, real-time operating condition information includes current-time information, voltage-time information, and power-time information.

In an actual scenario, if the battery is charged and discharged through current control, the real-time operating condition information is current-time information. If the battery is charged and discharged through voltage control, the real-time operating condition information is voltage-time information. If the battery is charged and discharged through power control, the real-time operating condition information is power-time information.

In this embodiment, the lithium battery parameters are the electrochemical parameters of the electrochemical model used.

A simulation module 102 is configured to perform computational simulation based on the real-time operating condition information and the electrochemical parameters through an electrochemical model, and obtain by analysis a deposition result of the lithium battery.

Specifically, the real-time operating condition information and the physical and chemical parameters of lithium battery parameter identification are loaded into a battery electrochemical model to be simulated.

In this embodiment, the electrochemical model simulates the just-loaded parameters in real time.

It should be noted that negative electrode lithium deposition generally occurs before lithium dendrites appear. Lithium dendrites are a particular form of lithium deposition. The growth of lithium deposits changing from mossy lithium to lithium dendrites happens when the mass transfer process cannot keep up with the electrochemical reaction rate, resulting in uneven lithium deposition. At this time, the liquid phase concentration near the lithium deposition is 0 or close to 0, and at this time, the deposition growth guided by the concentration field changes into that guided by the electric field, and the uneven growth form is dendrites.

Before assessing the presence of dendrites, the lithium deposition situation is first considered in the electrochemical model. The electrochemical model of the present invention may not be a full-order or other field coupled electrochemical model, but must be coupled with the influence of lithium deposition.

An early warning module 103 is configured to, using the deposition result obtained through electrochemical model simulation, provide early warning for the dendrite formation in the lithium battery.

In this embodiment, by providing early warning and simulation for dendrite formation, the growth of lithium battery dendrites is avoided, thereby protecting the safety of the lithium battery system.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. An early warning method for dendrite formation in a lithium battery, comprising:
acquiring real-time operating condition information and electrochemical parameters of the lithium battery;
performing a computational simulation based on the real-time operating condition information and the electrochemical parameters through an electrochemical model, and obtaining by analysis a deposition result of the lithium battery; and
using the deposition result obtained through electrochemical model simulation, providing early warning for the dendrite formation in the lithium battery.

2. The method of claim 1, wherein the performing the computational simulation based on the real-time operating condition information and the electrochemical parameters through the electrochemical model comprises:
simulating a relationship between a lithium plating amount and an overpotential of the lithium battery based on the real-time operating condition information and the electrochemical parameters through the electrochemical model.

3. The method of claim 2, wherein the simulating the relationship between the lithium plating amount and the overpotential of the lithium battery based on the real-time operating condition information and the electrochemical parameters through the electrochemical model comprises:
a formula of the overpotential of:
$${η}_{plating} = {Φ}_{s} - {Φ}_{e} - {E}_{plating} - {aFj}_{n} R ;$$
wherein η is the overpotential, Φₛ is a solid phase potential, Φₑ is a liquid phase potential, E_{plating} is an equilibrium potential for a lithium plating reaction, α is a specific surface area, jₙ is a solid-liquid exchange current density, and R is SEI impedance; and
the lithium plating amount satisfying the BV equation for a lithium plating side reaction by a formula of:
$${i}_{plating} = {i}_{o} [ exp ( \frac{{α}_{a} F {η}_{plating}}{RT} ) - exp ( \frac{{α}_{c} F {η}_{plating}}{RT} ) ] ; \\ {i}_{0} = {kCe}^{α} ;$$
wherein i₀ is a reference current density, Cₑ is a liquid phase concentration, a is an oxidation-reduction reaction coefficient, αₐ and α_{c} are anodic and cathodic transfer coefficients, respectively, F is a Faraday constant, R is a universal gas constant, T is a temperature in Kelvin, and i_{plating} is a lithium plating rate at a specific location per unit time.

4. The method of claim 3, wherein the obtaining by analysis the deposition result of the lithium battery comprises:
based on the liquid phase concentration of the lithium battery, obtaining by analysis the deposition result of the lithium battery.

5. The method of claim 4, wherein the based on the liquid phase concentration of the lithium battery, obtaining by analysis the deposition result of the lithium battery comprises:
judging whether or not the liquid phase concentration of the lithium battery is lower than a preset threshold value and is close to 0; and
when the liquid phase concentration of the lithium battery is lower than a preset threshold value and is close to 0, determining that the deposition result of the lithium battery is occurrence of dendrites in the lithium battery.

6. The method of claim 5, comprising:
if not, extrapolating the current operating condition of the lithium battery, and judging in different ways in different scenarios whether to provide the early warning for the lithium battery.

7. The method of claim 6, wherein the judging in different ways in different scenarios whether to provide the early warning for the lithium battery comprises:
when the lithium battery is in an energy storage power station within a preset stable range, extrapolating using a preset time average value of the lithium battery.

8. The method of claim 6, wherein the judging in different ways in different scenarios whether to provide the early warning for the lithium battery comprises:
when the lithium battery is in a frequency modulation power station, predicting the source-grid-load-storage in different cycles of the lithium battery.

9. The method of claim 6, wherein the judging in different ways in different scenarios whether to provide the early warning for the lithium battery comprises:
when the lithium battery is in a power tram, by extrapolating using a maximum current within a preset time period, judging whether the maximum current is close to 0 within the preset time threshold;
wherein the preset time threshold comprises a time threshold obtained through analysis according to a data sampling time of a lithium battery system and a control response time of the lithium battery system.

10. An early warning system for dendrite formation in a lithium battery, comprising:
an acquisition module, configured to acquire real-time operating condition information and electrochemical parameters of the lithium battery;
a simulation module, configured to perform computational simulation based on the real-time operating condition information and the electrochemical parameters through an electrochemical model, and obtain by analysis a deposition result of the lithium battery; and
an early warning module, configured to, using the deposition result obtained through electrochemical model simulation, provide early warning for the dendrite formation in the lithium battery.
